(19) United States
(12) Patent Application Publication
(10) Pub. No.: US 2002/0106499 A1
(43) Pub. Date: Aug. 8, 2002

(54) Ice breaker mat

(76) Inventor: John L. Cartier, Brad Ford, MA (US)

Correspondence Address: PERKINS, SMITH & COHEN LLP, ONE BEACON STREET, 30TH FLOOR, BOSTON, MA, 02108, US

(21) Appl. No.: 09/772,172

(22) Filed: Jan. 29, 2001

Related U.S. Application Data
(60) Provisional application No. 60/179,107, filed on Jan. 31, 2000.

(51) Int. Cl. B32B 5/02; B32B 27/12

(52) U.S. Cl. 428/304.4; 442/85

(57) ABSTRACT

The icebreaker mat is designed to be a safe and easy alternative to the removal of ice from a door entrance, porch walkway, and exterior steps. It is a product that is extremely easy to install, requires little or no maintenance. Once the ice has broken and is cleared from the mat, it will provide a safer slip-resistant mat to walk on throughout the winter months. The textured cover material is not only slip resistant, it also picks up the rays of the sun and eliminates ice from forming during the day light hours.

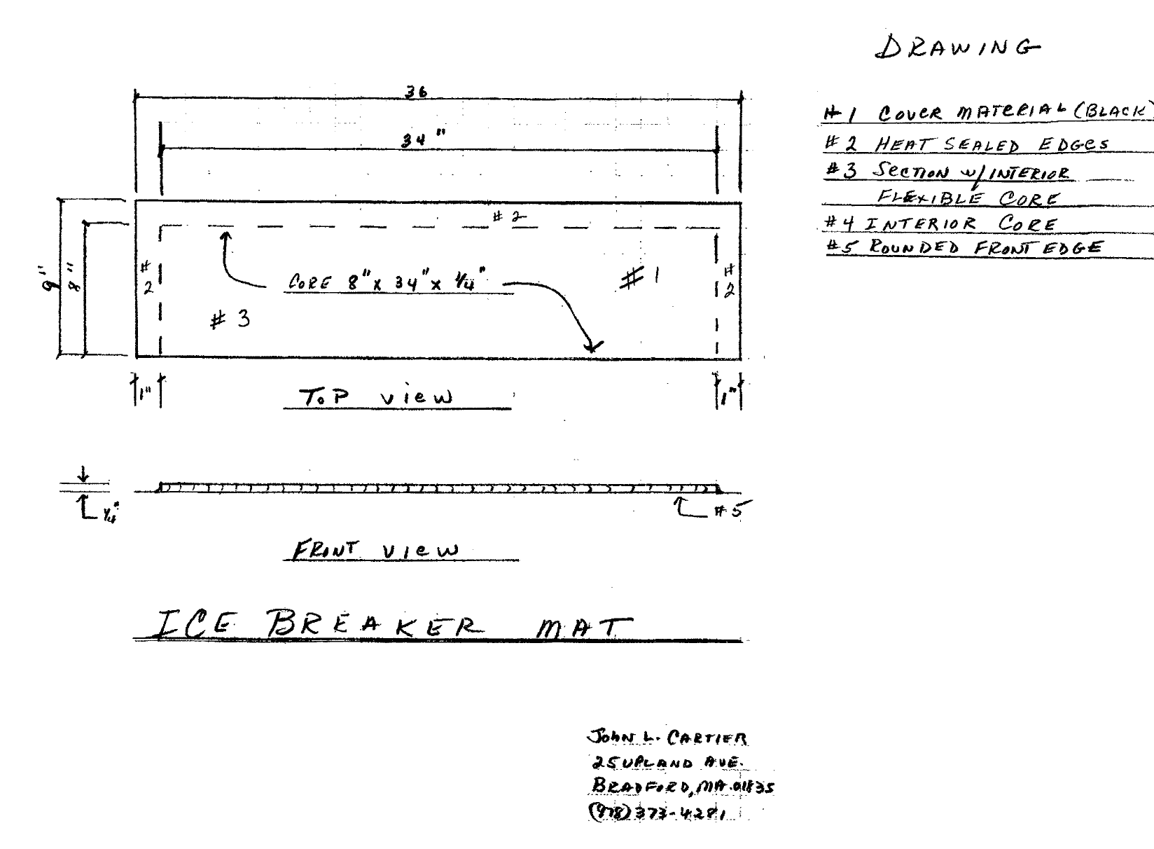

### BACKGROUND OF THE INVENTION

This invention is directed to a means of providing a safer means of remedying the problem of accumulated ice, and other slippery hazards on exterior stairs. This is accomplished by this invention which consists of an inner core material which is flexible, and an outer cover which is both slip resistant and water proof. The results being a product which will not support ice or allow ice to adhere to the cover material.

A variety of step pads and mats have been developed to perform a variety of functions, for example,

### CROSS REFERENCE TO RELATED APPLICATIONS

### U.S. Pat. No. 4,060,947 To Naka

### U.S. Pat. No. 5,357,724 To Sonoda

### U.S. Pat. No. 5,898,814 To Yamamoto

### U.S. Pat. No. 6,088,976 To Roy

All of which are illustrative of prior art. While these products are generally suitable for their particular purpose, as they are described they are not suitable for the purpose of this invention.

U.S. Pat. No. 4,000,947

Flexible Non-skid Strip with Reinforcing Web Member

Hiromitsu Naka, Shinmache Oaza, Saitama J. A. Yashio

A flexible non-skid strip is constituted by a main body extending along the length of the strip and adapted to be secured to the tread portion of a stair.

U.S. Pat. No. 5,357,724

Stair Tread

Munekatsu Sonoda

A stair tread, in which synthetic rubber is used to encase metal side core Portions arranged at the side edges of a substantially horizontal core section at a downward right-angle thereto.

U.S. Pat. No. 5,898,814

Anti-skid Stair Covering with Illuminating Areas Therein

Isao Yamamoto, Kashiware-Sji Ohgata

A stair covering which presents a stairs antiskid member capable of reducing the thickness of the entire antiskid member, enchancing the visual recognition of stairs by light.

U.S. Pat. No. 6,088,976

Removable non-skid Step Pad

Gillis Roy

The removable non-skid pad covers a portion of a corresponding step of an exterior stair so as to allow people to use it more safely. Any snow or ice Accumulations may be easily dislodged by removing the pad and skating it.

### BRIEF SUMMARY OF THE INVENTION

It is the object of this invention to provide a simple and convenient way to reduce the hazard of ice accumulating on exterior stairs, thereby reducing the possibility of bodily injury caused by slipping and falling on icy stairs.

This invention reduces the danger of falling by providing a slip-resistant, flexible mat which when secured to the exterior step of walkway will, by virtue of their body weight will compress the icebreaker mat and break and shatter the ice which has formed on the mat. Removal of the ice is simply done by pushing it from the mat with their foot, or brushing it from the mat, since it has a non-adhering quality to the exterior cover, which when the ice is broken will easily be removed from the mat.

This will than provide a clean slip-resistant surface to ascend and descend from their exterior stairs and porches.

### BRIEF DESCRIPTION OF THE DRAWING

List of reference numbers

1. Cover material

2. Heat sealed edges

3. Section with interior flexible core

4. Interior core

5. Rounded front edge

#1 is a top view of the cover material, which prior to assembly is cut approx. 18″×36″, but not limited to said size.

#2 is a top view of the approx. 1″ of the right, back and left side of the heat sealed portion of the icebreaker mat.

#3 represents the section of the mat which contains the flexible interior core.

#4 the interior core is 8″×34″×¼″ approx, but not limited to said size.

#5 shows the rounded front edge of the icebreaker mat

### DETAILED DESCRIPTION OF THE INVENTION

The cover material of this invention is made of pvc imitation leather and is made of knit cloth, adhesive-bonded and chemical fabric as basic materials and coated with pvc material after pressing and foaming. It is anti low temperature and aging, and has a long duration. Pvc imitation leather has reached the national standard of GB/T8948-94. It is made for exterior use, is waterproof, and is textured to produce a non-slip surface. The core is ¼″ styrofoam or it's equivalent, and measures 8″×34″, and is coated with an adhesive prior to being assembled with the cover material. This creates a stable stair mat with no moving parts. Once the cover and core are assembled, the right, back, and left side are sealed for a permanent seal, which makes the mat air and water tight. As long as the seal is not broken, it will retain it's flexibility and perform as intended.

The mat is than placed on a wooden step in late fall before the threat of ice and snow. It is secured by staples, two sided tape, velcro, or any other means the buyer wishes to attach them with, if the application is on brick or concrete stairs than they can be attached by four dabs of silicone sealer or a like material which will secure the mat for the duration of the winter. The mat is placed approx. ½″ in from the front edge of the step with the rounded edge to the front, than placing two staples on both ends and the back on the sealed part of the mat.

Once ice has formed, it only requires the weight of your body as you step on the mat to break the ice, and with little effort with your foot, the ice will fall from the mat, since the cover fabric also has a non-adhering quality, therefor the ice will not stick to the surface.

Although a detailed description of an icebreaker mat to one embodiment of the present invention has been provided, it should be understood that the scope of the invention is to be determined by the claims which follows and any modifications or alternatives apparent to one of ordinary skill in the art.

What I claim is:

1. An icebreaker mat comprising:
(A) A product made of slip-resistant, non-adhering, water-proof cover material, which contains a flexible core substance of styrofoam, foam, or other material suitable to provide the same results. Sealed so as to provide a water-proof, air tight flexible stair mat, pad of stair tread attachment.
(B) Once assembled and sealed into one unit, the icebreaker mat will provide a safe and convenient method of eliminating ice from exterior stairs and open walking areas of a porch or landing.
(C) Although the icebreaker mat has an overall size of 9″×36″×¼″, and is set at that dimension so as to provide walking space for two persons, side by side, it is not limited to that size, for it could be produced shorter, or longer if the need should arise. Therefor the icebreaker mat is not limited to the size in which it is being presented.
